(19) United States
(12) Patent Application Publication
(10) Pub. No.: US 2005/0148341 A1
(43) Pub. Date: Jul. 7, 2005

(54) Mobile phone control device for assisting search for people and things

(76) Inventor: Chen Fu Chang, Hsin Chu Hsien (TW)

Correspondence Address: CHANG CHEN FU, 235 CHUNG-HO BOX 8-24, TAIPEI HSIEN, 235, TW

(21) Appl. No.: 10/862,130

(22) Filed: Jun. 7, 2004

(30) Foreign Application Priority Data
Jan. 2, 2004 (TW) 93200076

(51) Int. Cl. H04Q 7/20

(52) U.S. Cl. 455/456.2; 455/456.3

(57) ABSTRACT

A mobile phone control device for assisting search for people and things comprises a central processing unit (CPU), a built-in memory chip, a signal detector, a direction judging circuit unit, a distance judging circuit unit, an audio circuit unit, a screen and a target signal emitting chip, thereby being capable of locating a missing person or a stolen thing installed with the target signal chip. The mobile phone equipped with the device receives a signal from the signal emitting chip and judges the direction and distance of the object the target signal chip disposed relative to the mobile phone. Thereby, a signal-emitting chip can be installed within a person or a thing for preventing missing or theft.

### FIELD OF THE INVENTION

The present invention relates to searching technology utilizing mobile phones for locating a person or a thing, more particularly to a mobile phone control device by which a signal emitted from an object can be received by a mobile phone. The mobile phone control device comprises a central processing unit (CPU), a built-in signal chip, a signal detector, a direction judging circuit unit, a distance judging circuit unit, an audio circuit unit, a screen and a target signal-emitting chip. The signal-emitting chip can be installed within an object, whereby the signal detector in a mobile phone can detect the signal emitted from the object. The direction judging and the distance judging circuit units determine the direction and distance of the object from the searching mobile phone based on the direction and the strength of the detected signal. The audio circuit unit sends off sound as the mobile phone approaches the object within a predetermined distance, and the screen indicates the location and distance of the object.

### BACKGROUND OF THE INVENTION

Besides the basic functions of receiving and making phone calls, some mobile phones of the prior art may also be a video game device, an Internet browser, a camera, a video camera or a data storage device. The conventional mobile phones up to date has yet to act as a searching device for lost people or things, or as a preventive device for forgetting whereabouts of an object.

### SUMMARY OF THE INVENTION

Accordingly, the primary objective of the present invention is to provide a mobile phone control device for assisting search for people and things wherein a signal-emitting chip is attached on a person or an object for sending a signal to a mobile phone equipped with control device for receiving the signal and thereby determine the direction and distance of the person or the object. Therefore, the present invention can be used to locate a missing child or a stolen automobile or a valuable whose whereabouts the owner forgets.

The various objects and advantages of the present invention will be more readily understood from the following detailed description when read in conjunction with the appended drawings.

### BRIEF DESCRIPTION OF THE DRAWINGS

FIG. 1 is a system block diagram of the present invention.

FIG. 2 is a system block diagram of the present invention wherein the functions for each block are specified.

### DETAILED DESCRIPTION OF THE PREFERRED EMBODIMENTS

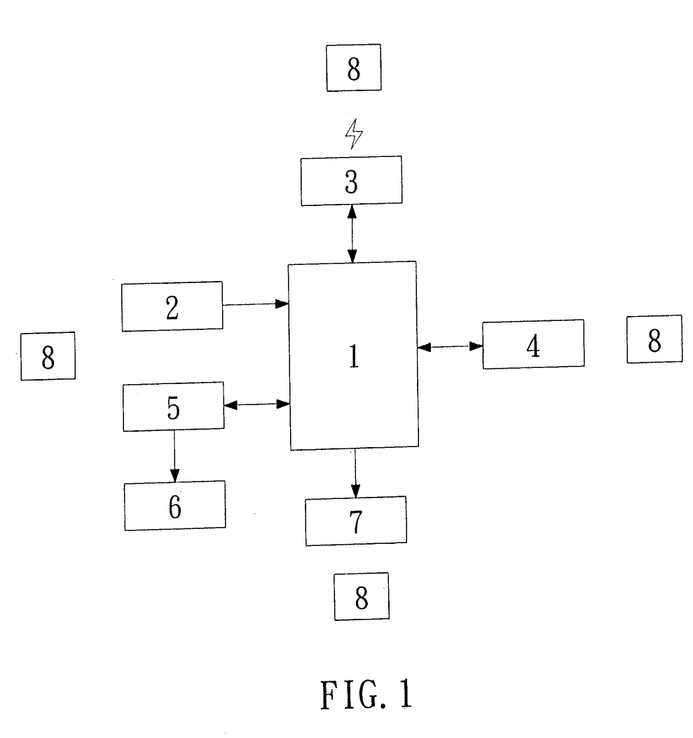

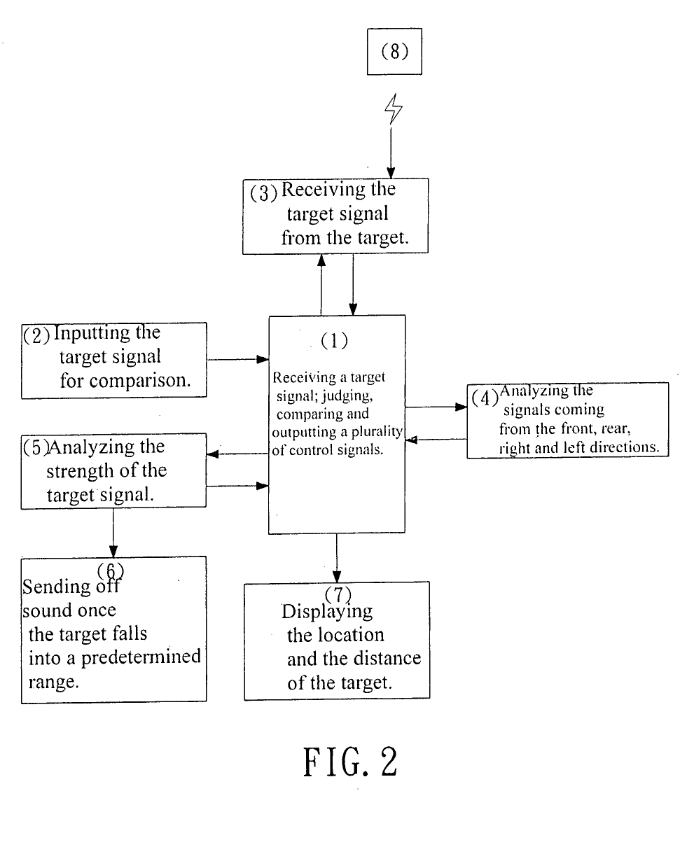

Referring to FIGS. 1 and 2, a mobile phone control device for assisting search for people and things according to the present invention comprises central processing unit 1, a built-in memory chip 2, a signal detector 3, a direction judging circuit unit 4, a distance judging circuit unit 5, an audio circuit unit 6, a screen 7 and a plurality of target signal-emitting chips 8. A mobile phone equipped with the control device acquires a searching function of locating a person or an object.

The central processing unit 1 receives, judges and compares a target signal and outputs a control signal.

The built-in memory chip 2 stores a set of codes each corresponding to a target signal-emitting chip 8 that is pre-installed in a search target.

The signal detector 3 can receives the target signal from anyone of the target signal-emitting chips 8 and relays the target signal to the central processing unit 1.

The direction judging circuit unit 4 receives the target signal from the central processing unit 1 and analyzes and determines a direction selected from right, left, front and rear. The direction judging circuit unit 4 transmits a direction signal back to the central processing unit 1.

The distance judging circuit unit 5 receives and analyzes the strength of the target signal from the central processing unit 1. The distance judging circuit unit 5 transmits a strength signal back to the central processing unit 1 for computing a distance corresponding to the strength signal.

The audio circuit unit 6 is capable of sending off sound if the strength signal produced in the distance judging circuit 5 exceeds a predetermined level.

The screen 7 receives the direction signal and the distance signal from the central processing unit 1 and displays the direction and the distance of the search target.

A plurality of target signal-emitting chips 8 are each pre-installed on a search target for providing a target signal receivable by the mobile phone within a predetermined range.

Referring to FIG. 2 again, one of the target signal-emitting chips 8 is attached to a target person or a target object. The code identification of the target signal-emitting chip 8 is sent into the built-in memory chip 2 within the mobile phone. To search the target, operate the mobile phone in a “search” mode and key in the code identification of the target signal-emitting chip 8. As the mobile phone enters a predetermined range around the target, the signal detector 3 will detect the signal emitted by the target signal-emitting chip 8 and relays the signal to the central processing unit 1. The central processing unit 1 then transmits the target signal respectively to the direction judging circuit unit 4 and the distance judging circuit unit 5. The direction judging circuit unit 4 is provided with four sensors respectively for sensing signals in the front, rear, left and right directions. The direction judging circuit unit 4 then determines the direction of the strongest signal and feeds back to the central processing unit 1. The distance judging circuit unit 5 analyzes the target signal and determines the distance from the target to the mobile phone, based on the strength of the target signal. The distance signal is then sent back to the central processing unit 1. The central processing unit 1 computes for a direction and a distance using the direction and the distance signals from the direction judging circuit unit 4 and the distance judging circuit unit 5, and controls the screen 7 to display the direction and the distance. As the strength of the target signal exceeds a predetermined level, the central processing unit 1 urges the audio circuit unit 6 to send off sound.

Therefore, the present invention can be used to locate a missing child or a stolen automobile or a valuable whose whereabouts the owner forgets.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

1. A mobile phone control device for assisting search for people and things, comprising:
a plurality of target signal-emitting chips each pre-installed on a search target for providing a target signal receivable by said mobile phone within a predetermined range;
a central processing unit for controlling receiving, judging and comparing said target signal and outputting a control signal;
a built-in memory chip for storing a set of codes each corresponding to a target signal-emitting chip installed in a search target;
a signal detector capable of receiving said target signal from anyone of said target signal-emitting chips and relaying said target signal to said central processing unit;
a direction judging circuit unit for receiving said target signal from said central processing unit, analyzing and determining a direction selected from right, left, front and rear, said direction judging circuit unit transmitting a direction signal back to said central processing unit;
a distance judging circuit unit for receiving and analyzing the strength of said target signal from said central processing unit, said distance judging circuit unit transmitting a strength signal back to said central processing unit for computing a distance corresponding to said strength signal;
an audio circuit unit capable of sending off sound if said strength signal produced in said distance judging circuit exceeds a predetermined level; and
a screen for receiving said direction signal and said distance signal from said central processing unit and displaying the direction and the distance of said search target;
whereby said mobile phone control device can provide a searching function of locating a person or an object attached with anyone of said target signal-emitting chips.
